(19) United States
(12) Patent Application Publication
(10) Pub. No.: US 2008/0084160 A1
(43) Pub. Date: Apr. 10, 2008

(54) IMAGE DISPLAY APPARATUS

(75) Inventor: Akira Hayama, Sagamihara-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/866,834

(22) Filed: Oct. 3, 2007

(30) Foreign Application Priority Data
Oct. 6, 2006 (JP) 2006-274998

(51) Int. Cl. H01J 1/62

(52) U.S. Cl. 313/505

(57) ABSTRACT

There is provided an image display apparatus comprising: a rear plate having a plurality of electron-emitting devices; a face plate having a plurality of fluorescence substances with different light emitting colors; and a plate-like spacer for defining an interval between the rear plate and the face plate, wherein the spacer has an aperture that allows a reflection electron generated on the face plate to pass through the plate-like spacer in a thickness direction and to reenter the face plate, and wherein the amount Et of the reflection electron that is irradiated to the fluorescence substance closest to the spacer through the aperture is defined as Et>0.3×En, where the amount of the reflection electron to be irradiated to the fluorescence substance is En when no spacer is located.

### BACKGROUND OF THE INVENTION

1. Field of the Invention

The present invention relates to a flat-type image display apparatus that is configured by using an electron-emitting device.

2. Description of the Related Art

In Japanese Patent Application Laid-Open No. 7-45221, as a structure for preventing damage of a metal back and making positioning simple upon connection between a face plate and a spacer, a structure such that the face plate is provided with a rib is disclosed.

In U.S. Pat. No. 5,576,596, as a structure for decreasing mixture of colors and reducing a damage of a member of the face plate, a structure of the face plate provided with a rib is described.

In a specification of Japanese Patent No. 3270054, there is described a structure such that a rib as a shielding structure is disposed on a face plate in an electric field emitting apparatus having an inner structure for aligning a fluorescence pixel in a corresponding electric field emitter in order to decrease halation due to a reflection electron.

Because of halation due to a reflection electron, color unevenness is generated in the vicinity of a spacer. According to a conventional structure, a reduction capability of color unevenness is not enough. Therefore, a structure such that the color unevenness can be more decreased has been desired.

### SUMMARY OF THE INVENTION

Therefore, an object of the present invention is to provide an image display apparatus that can prevent halation due to a reflection electron and decrease color unevenness to be generated caused by the halation.

An image display apparatus according to a first aspect of the present invention includes: a rear plate having a plurality of electron-emitting devices; a face plate having a plurality of fluorescence substances with different light emitting colors; and a plate-like spacer for defining an interval between the rear plate and the face plate, wherein the spacer has an aperture that allows a reflection electron generated on the face plate to pass through the plate-like spacer in a thickness direction and to reenter the face plate, and wherein the amount Et of the reflection electron that is irradiated to the fluorescence substance closest to the spacer by passing through the aperture is defined as Et>0.3×En, where the amount of the reflection electron to be irradiated to the fluorescence substance is En when no spacer is located.

An image display apparatus according to a second aspect of the present invention includes: a rear plate having a plurality of electron-emitting devices; a face plate having a plurality of fluorescence substances with different light emitting colors; and a plate-like spacer for defining an interval between the rear plate and the face plate, wherein barrier members are arranged in a direction that crosses the plate-like spacer, and wherein the barrier members are arranged at the opposite sides of the fluorescence substance having the highest light emission efficiency among the fluorescence substances with different light emitting colors, and wherein a height h of the barrier member has a relation satisfying h>0.1×H for a distance H between the face plate and the rear plate.

An image display apparatus according to a third aspect of the present invention includes: a rear plate having a plurality of electron-emitting devices; a face plate having a plurality of fluorescence substances with different light emitting colors; and a plate-like spacer for defining an interval between the rear plate and the face plate, wherein barrier members are arranged in a direction that crosses the plate-like spacer, and wherein the barrier members are arranged among the fluorescence substances with different light emitting colors, and wherein a height h of the barrier member has a relation satisfying h>0.075×H for a distance H between the face plate and the rear plate.

Further features of the present invention will become apparent from the following description of exemplary embodiments with reference to the attached drawings.

### BRIEF DESCRIPTION OF THE DRAWINGS

FIGS. 1A to 1D are views showing a method for manufacturing a face plate of an embodiment according to the present invention;

FIG. 2 is a perspective view paternally showing a constitution example of the image display apparatus according to the present invention;

FIGS. 3A to 3C are views showing a shielding effect of a reflection electron due to a spacer;

FIGS. 4A and 4B are views showing a transmission effect of the reflection electron according to the present invention;

FIG. 5 is a view showing color difference Δu′v′ between a pixel located on a part having no spacer and a pixel closest to the spacer for a transmission rate Et/En of the reflection electron;

FIGS. 6A and 6B are views showing an aperture of the spacer according to the present invention;

FIG. 7 is a view showing a relation between an aperture ratio of the spacer and a transmission rate of the reflection electron according to the present invention;

FIGS. 8A and 8B are views showing an aperture that is provided between the spacer and the face plate according to the present invention;

FIGS. 9A and 9B are views showing an aperture that is provided between the spacer and the face plate according to the present invention;

FIGS. 10A and 10B are views explaining a color difference reduction effect of a barrier member according to the present invention;

FIG. 11 is a view showing a relation between the height of the barrier member and the color difference reduction effect according to the present invention;

FIG. 12 is a pattern diagram showing a shielding effect upon re-entry of a reflection electron due to the barrier member according to the present invention;

FIG. 13 is a view showing a relation between the height of the barrier member and a ratio that the reflection electron reaches the fluorescence substance according to the present invention;

FIG. 14 is an explanatory view of the color difference reduction effect of the barrier member according to the present invention;

FIG. 15 is a view showing a relation between the height of the barrier member and the color difference reduction effect according to the present invention;

FIG. 16 is an explanatory view of the shielding effect upon an escape and re-entry of a reflection electron due to the barrier member according to the present invention;

FIG. 17 is a view showing a relation between the height of the barrier member and a ratio that the reflection electron reaches the fluorescence substance according to the present invention; and

FIGS. 18A to 18D are views explaining a face plate of an embodiment according to the present invention.

### DESCRIPTION OF THE EMBODIMENTS

The present invention provides an image display apparatus having: a rear plate having a plurality of electron-emitting devices; a face plate having a plurality of fluorescence substances with different light emitting colors; and a plate-like spacer for defining an interval between the rear plate and the face plate.

According to a first invention, the spacer has an aperture that allows a reflection electron generated on the face plate to pass through the plate-like spacer in a thickness direction and to reenter the face plate; and the amount Et of the reflection electron that is irradiated to the fluorescence substance closest to the spacer by passing through the aperture is defined as Et>0.3×En, where the amount of the reflection electron to be irradiated to the fluorescence substance is En when no spacer is located.

In addition, according to a second invention, barrier members are arranged on the face plate in a direction that crosses the plate-like spacer; the barrier members are arranged at the opposite sides of the fluorescence substance having the highest light emission efficiency among the fluorescence substances with different light emitting colors; and the height h of the barrier member has a relation satisfying h>0.1×H for the distance H between the face plate and the rear plate.

Further, according to a third invention, barrier members are arranged on the face plate in a direction that crosses the plate-like spacer; the barrier members are arranged among the fluorescence substances with different light emitting colors; and the height h of the barrier member has a relation satisfying h>0.075×H for the distance H between the face plate and the rear plate.

According to the present invention, the color difference (color deviation) in the vicinity of the spacer takes a value below an allowed value, so that it is possible to improve an image quality.

Hereinafter, an embodiment of the present invention will be described.

An image display apparatus according to the present invention is an apparatus for forming an image due to irradiation of an electric beam. As an electron-emitting device, an electric field emitting device, an MIM-type electron-emitting device, and a surface conduction electron-emitting device or the like can be used. Particularly, the surface conduction electron-emitting device has a simple structure and can be easily made and many surface conduction electron-emitting devices can be formed across a large area, so that it can be said that this surface conduction electron-emitting device is a preferable configuration to which the present invention is applied.

In the following embodiment, an example such that the present invention is applied to an image display apparatus having: a plurality of pixels configured by a plurality of fluorescence substances with different colors and devices for activating these fluorescence substances; and a drive circuit for outputting a drive signal for driving these devices is illustrated. However, the explanation for the image display apparatus having these plural pixels and the drive circuit will not be described herein because this apparatus has been publicly known.

The embodiment of the present invention will be specifically described bellow taking the image display apparatus using the surface conduction electron-emitting device (hereinafter, it may be described as an SED).

According to the present example, an SED panel that is arranged having a multi electron source and an image forming member opposed with each other in a thin-type vacuum container is used. The multi electron source is made by arranging many electron sources, for example, cold cathode devices on a substrate. An image forming member forms an image due to irradiation of an electron. Between the multi electron source and the image forming member, a spacer serving as a constitutional support body is disposed. Electron-emitting devices are arranged in a simple matrix by a wiring in a row direction and a wiring in a column direction. From the device that is selected by a row/column electrode bias, an electron is emitted. By accelerating the electron with a high voltage to collide with the fluorescence substance, light emission is obtained.

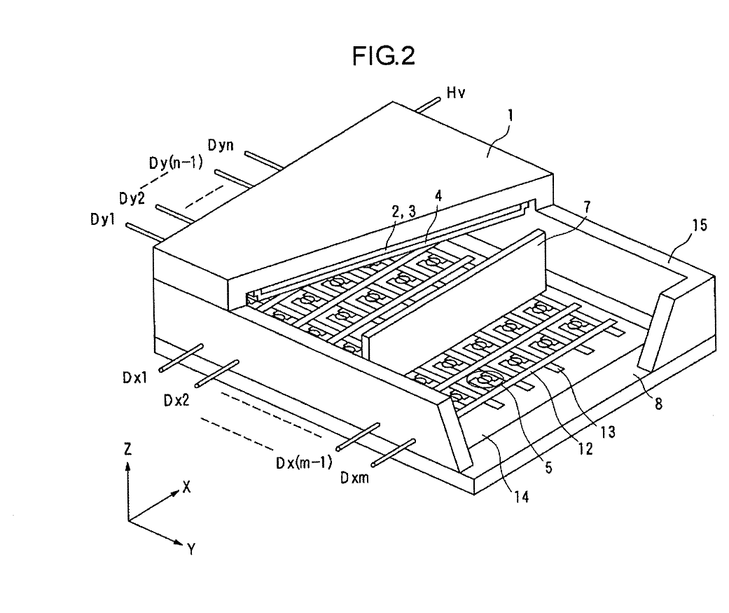

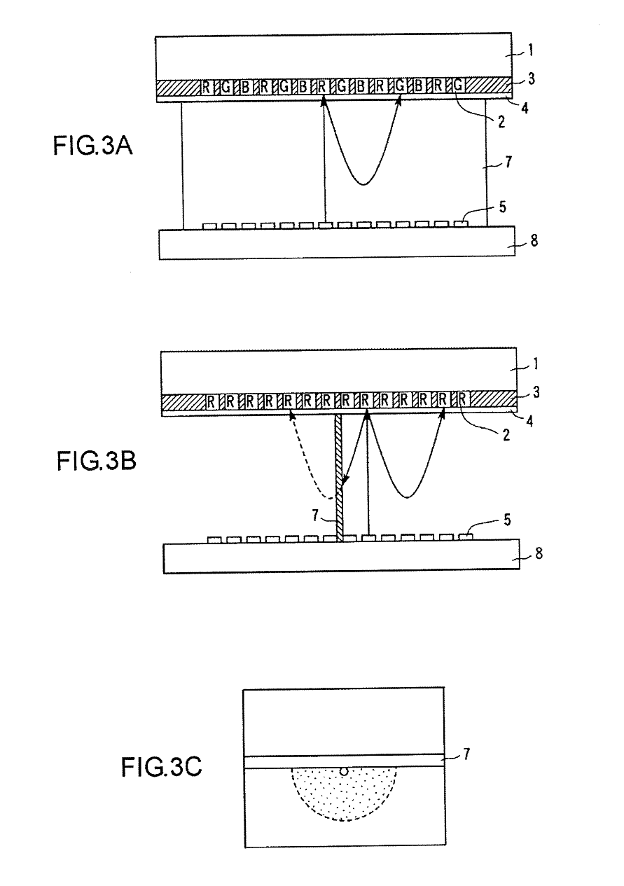

At first, halation due to the reflection electron that is a problem of the present invention will be described with reference to FIGS. 3A to 3C. In FIG. 3A, a cross sectional pattern diagram in a row direction (a direction that is parallel with a spacer) of the image display apparatus as shown in FIG. 2 is illustrated. In addition, in FIG. 3B, a cross sectional pattern diagram in a column direction (a direction that is orthogonal to the spacer, a thickness direction of the spacer) of the image display apparatus is illustrated in the same way. Further, FIG. 3C is a plan view of a face plate and FIG. 3C shows a distribution of light emission when only the vicinity of the spacer is selectively light-emitted.

In FIGS. 3A and 3B, a rear plate 8 has an electron-emitting device 5. In addition, the face plate 1 has a fluorescence substance (a fluorescence substance film) 2 having three emission colors (red (R), green (G), and blue (B)), a black stripe 3 that is arranged between respective fluorescence substances, and a metal back 4. In addition, a spacer 7 is arranged so as to contact the both sides, namely, the side of the face plate 1 and the side of the rear plate 8. The shape of the spacer 7 is a plate shape. In this way, the spacer, of which thickness is smaller than its height and its width, is referred to as a plate-like spacer.

Here, the case of selecting one picture element in the vicinity of the spacer and emitting an electron from the electron source will be considered. The electron emitted from the electron source is accelerated by a high voltage potential applied to the metal back 4 to be directed to the face plate 1. In this case, as an acceleration voltage to be applied to the metal back 4, a voltage within the range of 5 to 15 kV is preferably used in many cases. The accelerated electron has a high energy, so that this electron passes through the metal back 4 without losing the energy so much to be irradiated to the fluorescence substance 2 (here, R: a red fluorescence substance).

Here, certain parts of the irradiated electrons are reflected with little loss of energy to be made into reflection electrons of a high energy (they may be referred to as a backscattered electron or an elastic scattered electron). Although the reflection electron flies to the rear plate 8, the reflection electron is accelerated up to a high voltage potential applied to the metal back 4 again to reenter the face plate 1 in a parabola curve mostly. The reflection electron flies not only in a direction of an incidence electron but also in various directions, so that the reflection electron is also irradiated to the picture element other than the selected one. Accordingly, light emission of the picture element other than the selected one is generated and this leads to decrease of contrast and mixture of colors (a phenomenon that a color purity is decreased because of light emission of the picture element other than the selected color; color impurity). This phenomenon is referred to as halation of the reflection electron.

It is obvious that decrease of contrast and mixture of colors deteriorate an image quality of the image display apparatus. However, it is ununiformity of the vicinity of the spacer 7 that further deteriorates the image quality. As described above, the reflection electron flies through a space between the face plate 1 and the rear plate 8 to reenter the face plate 1 and if there is the spacer 7 on the way, the reflection electron is obviously shielded by the spacer 7 (FIG. 3B). As a result, the light emission of the selected picture element and the light emission due to the reflection electron (halation) are distributed being effected by the spacer 7 as shown in FIG. 3C. In other words, halation due to the reflected electron is largely different in the vicinity of the spacer 7 and at a place separated from the spacer 7, so that it can be said that ununiformity is generated by the spacer 7.

The light emission is most effected by the ununiformity above when a certain color is emitted. For example, when displaying an image of a red color only, due to halation of the reflection electron, the light emissions of blue and green are mixed. Here, only the vicinity of the spacer 7 has little halation as described above. Accordingly, mixture of colors is little only in the vicinity of the spacer 7 and a color purity is increased. Therefore, a color difference is generated between the vicinity of the spacer 7 and other places. It is a picture element nearest to the spacer 7 of which color is most different from the space having no spacer 7, and in this example, this is a picture element of a row next to the spacer 7. The fluorescent substance to form this picture element is referred to as a fluorescence substance closest to the spacer 7. In the case of using a plate-like spacer, particularly, susceptibility due to this color difference is large and this remarkably deteriorates an image quality. As a result, an object of the image display apparatus is to make a color difference of light emission of the fluorescence substance closest to the spacer below an allowed value, preferably, below a detectable limit value.

The inventors of the present invention decreased a color difference in the vicinity of the spacer above according to the following methods as a result of keen examinations.

Namely,

the inventor(s) of the present invention found that the above-described problem could be solved by:

(1) decreasing a shielding effect of a reflection electron due to the spacer,

(2) decreasing irradiation to a fluorescence substance having the highest light emission efficiency by a barrier member preventing the reflection electron from reentering the fluorescence substance, or

(3) arranging a barrier member so as not to get the reflection electron out of the selected picture element.

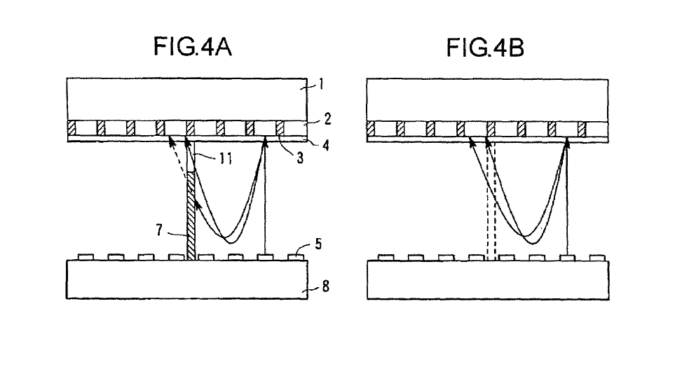

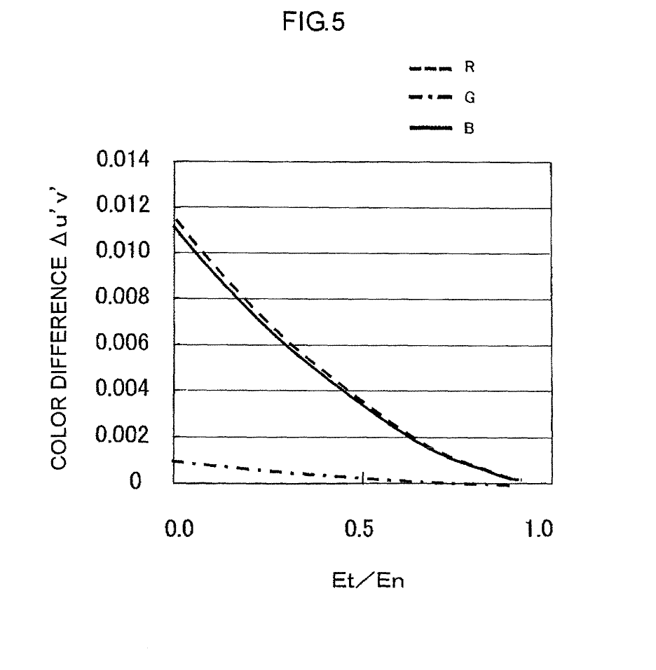

Decrease of a reflection electron shielding effect of the spacer, which is a characteristic of the present invention, will be described below. As described above, a color difference is generated because the amounts of the reflection electrons on the place having no spacer are different from the amounts of the reflection electrons on the place having a spacer. With respect to the shielding effect of the reflection electron, the explanation will be given with reference to FIGS. 4 and 5. FIG. 4A is a pattern diagram showing a manner that an electron passes through the plate-like spacer 7 having an aperture 11. FIG. 4A shows that the electron is irradiated to the fluorescence substance closest to the spacer through the aperture 11. Here, the amount of the electron that is irradiated to the fluorescence substance 2 closest to the spacer 7 through the plate-like spacer 7 in a thickness direction (from right to left in the drawing) is defined as Et. FIG. 4B is a pattern diagram showing the case that there is no spacer. Assuming that there is a spacer as well as above, the amount of the electron passed through this virtual spacer (a broken line) in the thickness direction (from right to left in the drawing) is defined as En. Et/En represents a transmission rate of the reflection electron with respect to the fluorescence substance 2 closest to the spacer 7. Hereinafter, this transmission rate may be simply described as a transmission rate of a reflection electron.

FIG. 5 shows a color difference Δu′v′ between a pixel of a part having no spacer 7 and a pixel closest to the spacer 7 for the transmission rate Et/En of the reflection electron. Although this relation is changed depending on the structure of the face plate 1, for example, the kind of the fluorescence substance 2, the kind and the thickness of the metal back 4, and arrangement of the pixel or the like, the inventor(s) of the present invention examined on various conditions and found the above relation. Further, Δu′v′ represents a distance between two colors on a CIE1976UCS chromaticity coordinate.

Next, due to a subjective appraisal, a level (an allowed value) that can permit a color difference in the vicinity of the spacer and a level (a detectable limit) that cannot detect the color difference are obtained. As a result of subjective appraisals of plural persons, an allowed value Δu′v′=0.006 and a detectable limit Δu′v′=0.002 are obtained.

From the above descriptions, in order to make the color difference of the pixel closest to the spacer below the allowed value, the transmission rate of the reflection electron is needed more than 0.3. In addition, in order to make this color difference below the detectable limit, the transmission rate of the reflection electron is needed more than 0.7.

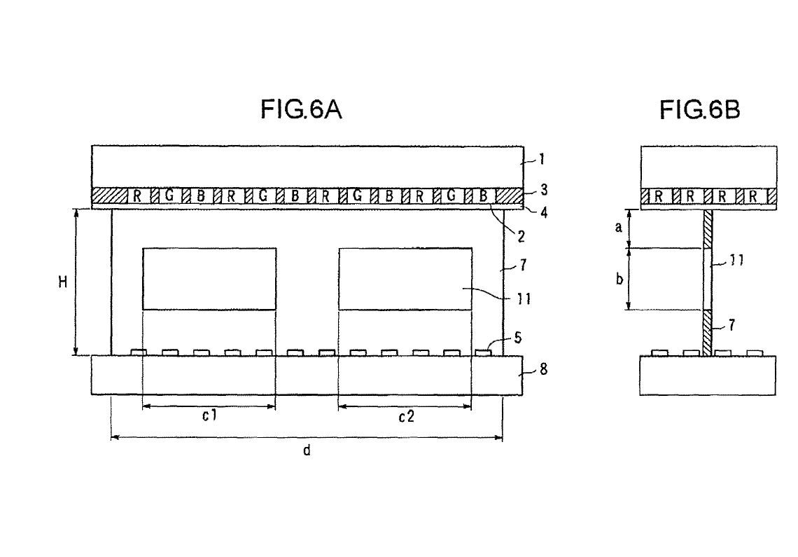

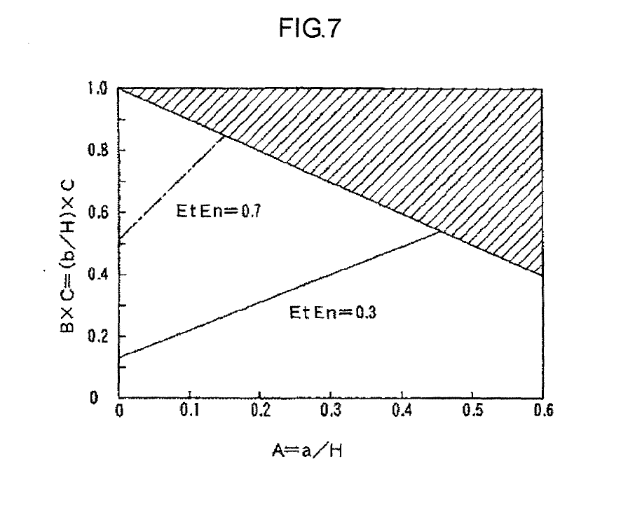

Next, the spacer shape for realizing the reflection electron transmission rate above will be described with reference to FIGS. 6A, 6B, and 7. As a structure for transmitting through the reflection electron, an aperture to be disposed on the spacer is considerable. FIGS. 6A and 6B show pattern diagrams of the spacer 7 having the aperture 11. FIG. 6A is a cross sectional pattern diagram in a direction that is parallel with the spacer 7 and FIG. 6B is a cross sectional pattern diagram in a direction that is orthogonal to the spacer 7. A distance between the face plate 1 and the rear plate 8 is defined as H (in this drawing, this is also a height of the spacer 7), a distance from the face plate 1 to the aperture 11 is defined as a, the height of the aperture 11 is defined as b, the sizes of the aperture 11 in a lateral direction are defined as c1 and c2, and the length of the spacer 7 is defined as d, respectively. Here, in order to increase the transmission rate of the electron that can irradiate the pixel nearest to the spacer 7, the followings are necessary.

Namely,

(1) to dispose the aperture 11 on the place near the face plate as much as possible (the place where a is small),

(2) to make the measurement b of the aperture 11 large, and

(3) to make an aperture ratio C in the lateral direction of the aperture 11 large.

In this case, the aperture ratio C in the lateral direction is defined as C=(c1+c2)/d. In addition, if the aperture 11 is not shaped in a simple square, it is decided that the average aperture ratio is used.

As described above, the transmission rate of the reflection electron is obtained from the amount of the electrons to be irradiated to the pixel nearest to the spacer 7 passing through the aperture 11 while calculating an electron trajectory between the face plate 1 and the rear plate 8. This result is shown in FIG. 7. In the drawing, a lateral axis A represents the position of the aperture for a panel interval (a distance between the face plate and the rear plate) and this is obtained by A=a/H. In addition, in the drawing, a longitudinal axis of B×C is a numeric value representing the size of the aperture and it is obtained by B×C=(b/H)×C. A right-upper area shown by hatching is formed in a shape that the aperture is not made, namely, a shape that the position of the aperture extends to the outside of the rear plate. In the drawing, a solid line represents a condition that the transmission rate of the reflection electron Et/En=0.3 is established. In an area that is left-upper from the solid line, Et>0.3×En is established. In addition, a dashed line in a graph represents a condition that the transmission rate of the reflection electron Et/En becomes 0.7. In an area that is left-upper from the dashed line, Et>0.7×En is established. If this condition is made into a formulation, a condition that the transmission rate of the reflection electron is larger than 0.3 becomes as follows; namely, B×C>0.9×A+0.13. In addition, a condition that the transmission rate of the reflection electron is larger than 0.7 becomes as follows; namely, B×C>2.3×A+0.5.

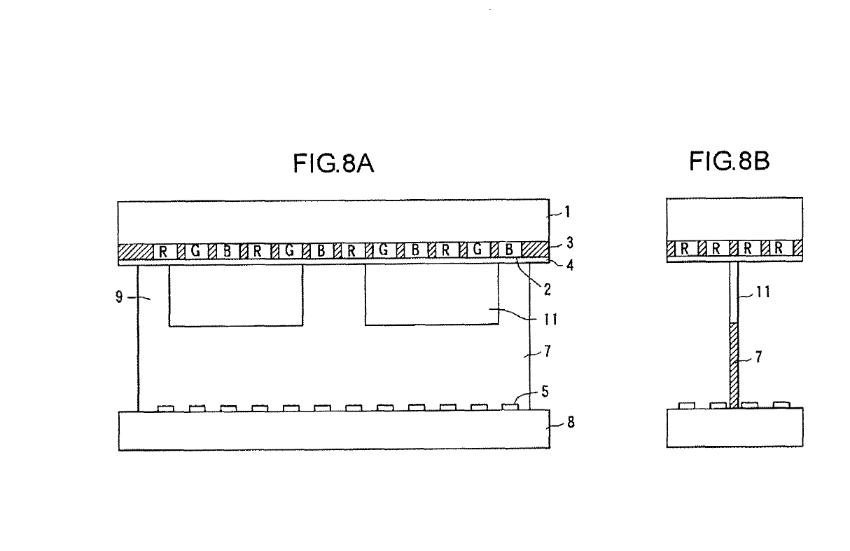

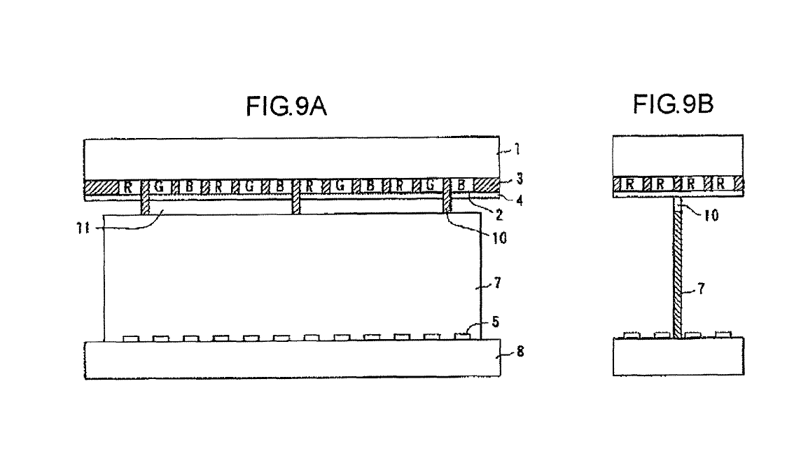

Although it is the same concept, in order to make the transmission rate of the reflection electron larger, a structure to provide the aperture between the spacer 7 and the face plate 1 may be also used other than providing the aperture on the spacer 7 itself. Such a shape is shown in FIGS. 8A, 8B, 9A, and 9B. In the drawings, FIG. 8A and FIG. 9A are cross sectional pattern diagrams in parallel with the spacer 7, and FIG. 8B and FIG. 9B are cross sectional pattern diagrams in an orthogonal to the spacer 7. FIGS. 8A and 8B show an example that a projection shape 9 is disposed on the spacer 7 in order to form an aperture between the face plate 1 and the spacer 7. In addition, FIGS. 9A and 9B show an example that a projection shape 10 is disposed on the face plate 1 in order to form an aperture between the face plate and the spacer. In any case, in the above-described mathematical expressions, A=0 (namely, the aperture 11 contacts the face plate 1) is established.

Next, as a method to make a color difference in the vicinity of the spacer smaller, a method for making mixture of colors itself smaller at the same time as making the transmission rate of the spacer large will be described. As described above, the mixture of colors is generated when the reflection electron reenters other color. In most cases, the light emission efficiency of the fluorescence substance is different for each color. From the viewpoint of a standard luminosity factor, the light emission efficiency of the fluorescence substance of green light emission is high in most cases. The fluorescence substance having the high light emission efficiency highly contributes to the mixture of colors in the case of emitting lights for other colors. According to an example cited in this case, it can be said that the green fluorescence substance largely influences the red and blue fluorescence substances. In other words, if arrival of the reflection electron to the green fluorescence substance can be reduced, the mixture of colors can be largely decreased.

If the mixture of colors due to the reflection electron is reduced because of the reason above, the color difference in the vicinity of the spacer is also reduced because it is a cause of the color difference that a degree of the mixture of colors is different between the vicinity of the spacer and other places and naturally, the color difference in the vicinity of the spacer is also made smaller if the mixture of colors itself is made smaller.

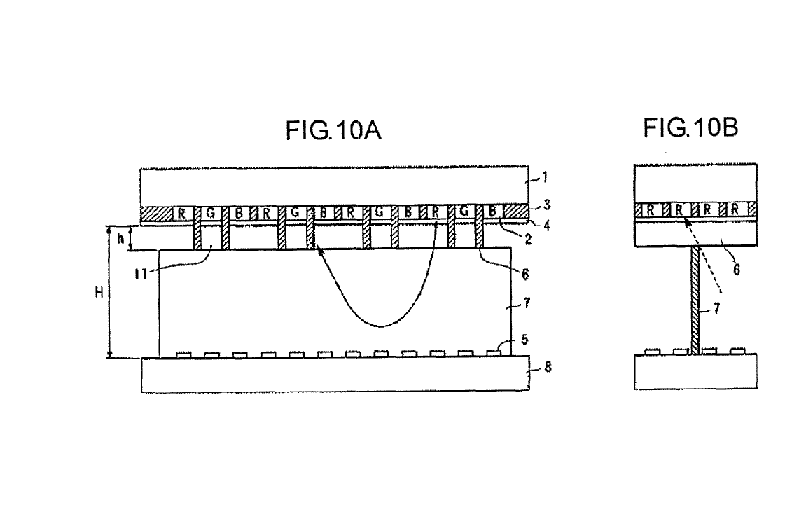

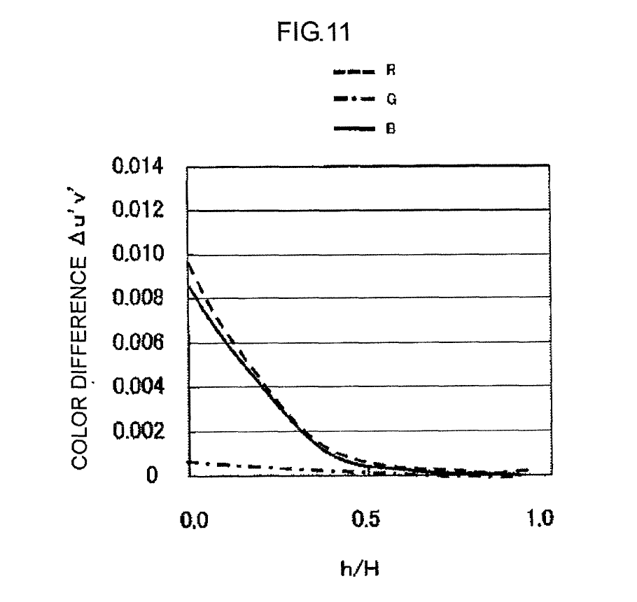

The above-described structure will be described with reference to FIGS. 10A, 10B, and 11. FIG. 10A is a cross sectional pattern diagram in a direction that is parallel with the spacer 7 and FIG. 10B is a cross sectional pattern diagram in a direction that is orthogonal to the spacer 7. Barrier members 6 (they may be represented as ribs) are disposed on the opposite sides of a green fluorescence substance (G) having the highest light emission efficiency among the fluorescence substances of three colors. When the reflection electron of a trajectory as shown by a solid line arrow in FIG. 10A is generated, reenter of the reflection electron is prevented by the barrier member 6. Thereby, the mixture of colors itself is reduced and the color difference in the vicinity of the spacer 7 is also reduced. Further, since the aperture 11 is formed between the face plate 1 and the spacer 7 by the barrier member 6, the reflection electron hitting other colors passing through the aperture 11 as shown by a dashed-line arrow in FIG. 10B is generated (namely, the transmission rate of the reflection electron becomes larger than 0).

Due to these multiple effects, the color difference in the vicinity of the spacer is reduced. These effects will be described in FIG. 11. In FIG. 11, the lateral axis represents a rib height h for the panel interval H and the longitudinal axis represents a color difference Δu′v′ between a pixel of a part having no spacer and a pixel closest to the spacer. Accordingly, in order to make the color difference of the pixel closest to the spacer below an allowed value, h/H may be larger than 0.1. In addition, in order to make the color difference of the pixel closest to the spacer below a detectable limit value, h/H may be larger than 0.3.

In addition, the mixture of colors reduces representable colors of the image display apparatus. This makes the displayed image to be in an unnatural color. Therefore, the allowed value for a degree of the mixture of colors is obtained by a subjective appraisal. As a result, although the image display apparatus having no structure in order to shield the reflection electron (FIG. 3) has a sense of discomfort, setting the degree of the mixture of colors at less than about 80% by shielding the reflection electron, this image display apparatus has no sense of discomfort.

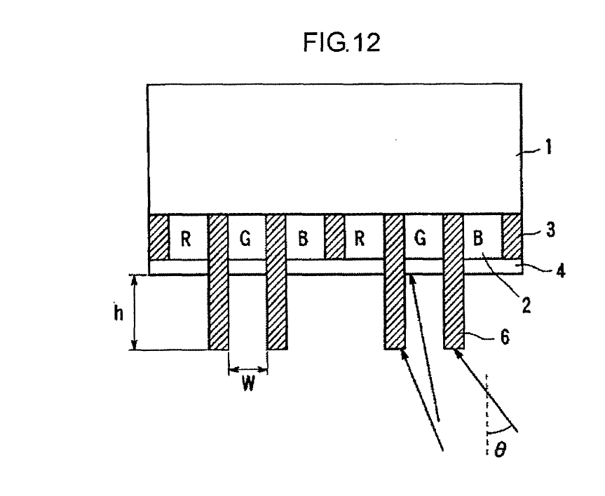

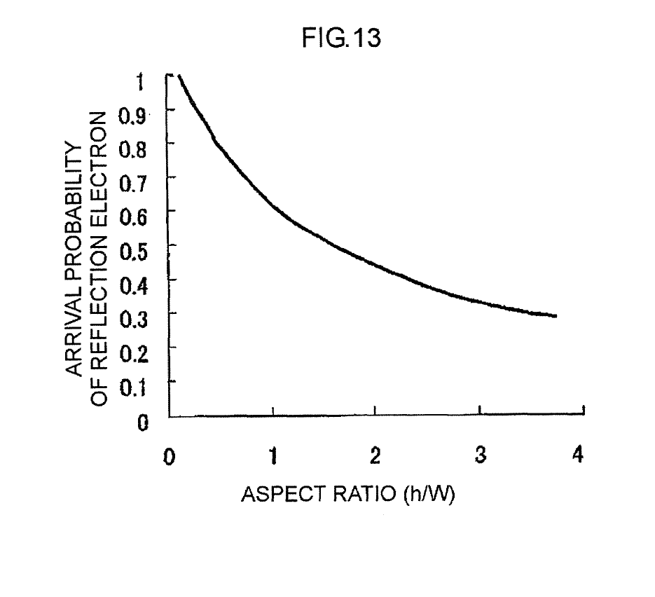

A shielding effect of a reflection electron due to the barrier member 6 will be described with reference to FIG. 12 and FIG. 13. FIG. 12 is a pattern diagram for representing a shielding effect when the reflection electron reenters the fluorescence substance and a reference mark h represents a height of the barrier member 6 and a reference mark W represents the interval of the barrier member 6 (namely, a width of a fluorescence substance). Unless the image is displayed under a very limited condition, namely, the ignition of only one picture element, as shown by a solid line arrow of FIG. 12, the reflection electron may enter with various angles. Among these various angles, the reflection electron with only a small incidence angle θ can collide with the fluorescence substance. The larger h is for the width W of the fluorescence substance, namely, the larger an aspect ratio h/W is, these effects become larger. The result of obtaining these effects is shown in FIG. 13. The lateral axis of FIG. 13 represents the above-described aspect ratio and the longitudinal axis represents an arrival probability of the reflection electron. Defining the arrival amount of the reflection electron when there is no barrier member 6 as 1, FIG. 13 shows a degree of the arrival probability of the reflection electron when the aspect ratio of the barrier member 6 is larger. Here, defining the reflection electron amount to be irradiated to the fluorescence substance sandwiched by the barrier members 6 as R1 and defining the reflection electron amount to be irradiated to the fluorescence substance where there is no barrier member 6 as R2, the mixture of colors has no particular distinction when R1<0.8×R2 is established. Accordingly, as described above, the aspect ratio h/W may be made larger than 0.5 in order to set the amount of the mixture of colors due to the reflection electron at less than 80%.

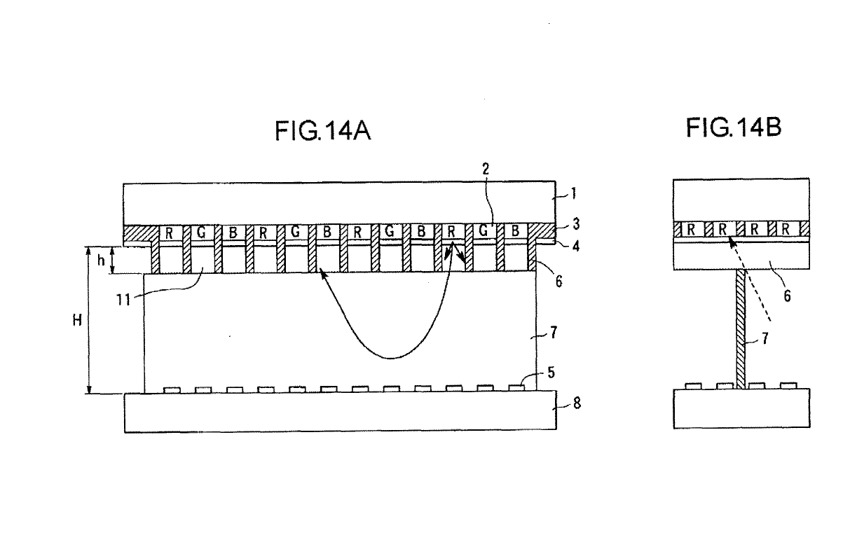

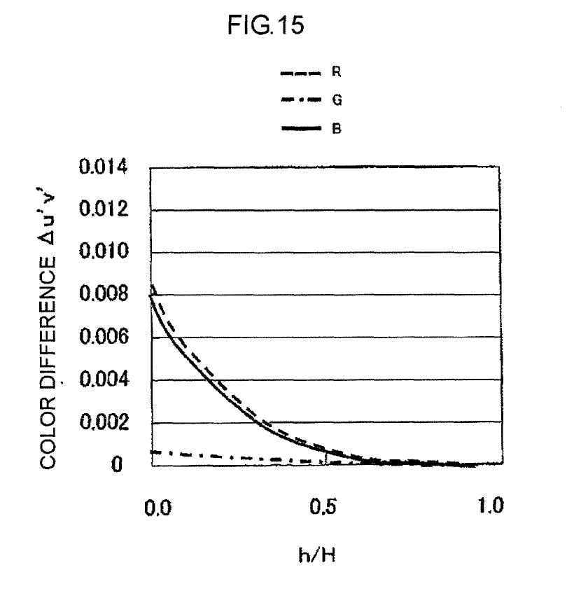

Next, as a method for further reducing the mixture of colors and thereby, reducing the color difference in the vicinity of the spacer, a structure for making the reflection electron hard to eject from the selected picture element will be described with reference to FIGS. 14A, 14B, and 15. FIG. 14A is a cross sectional pattern diagram in a direction that is parallel with the spacer 7 and FIG. 14B is a cross sectional pattern diagram in a direction that is orthogonal to the spacer 7. As shown in FIG. 14A, the barrier members 6 are disposed on the opposite sides of each fluorescence substance. When a reflection electron of a trajectory as shown by a solid line arrow in FIG. 14A is generated, ejection of the reflection electron from a selected fluorescence substance (R) is prevented by the barrier member 6. In addition, an effect to prevent reentry above is obtained, so that the mixture of colors itself is reduced and the color difference in the vicinity of the spacer is also reduced. Further, since the aperture 11 is generated between the face plate 1 and the spacer 7 by the barrier member 6, as shown by a broken line arrow in FIG. 14B, a reflection electron to collide with the fluorescence substance passing through the aperture 11 is generated (namely, the transmission rate of the reflection electron is larger than 0).

Due to these multiple effects, the color difference in the vicinity of the spacer is reduced. These effects will be described in FIG. 15. In FIG. 15, the lateral axis represents a rib height h for the panel interval H and the longitudinal axis represents a color difference Δu′v′ between a pixel of a part having no spacer and a pixel closest to the spacer. Accordingly, in order to make the color difference of the pixel closest to the spacer below an allowed value, h/H may be larger than 0.075. In addition, in order to make the color difference of the pixel closest to the spacer below a detectable limit value, h/H may be larger than 0.2.

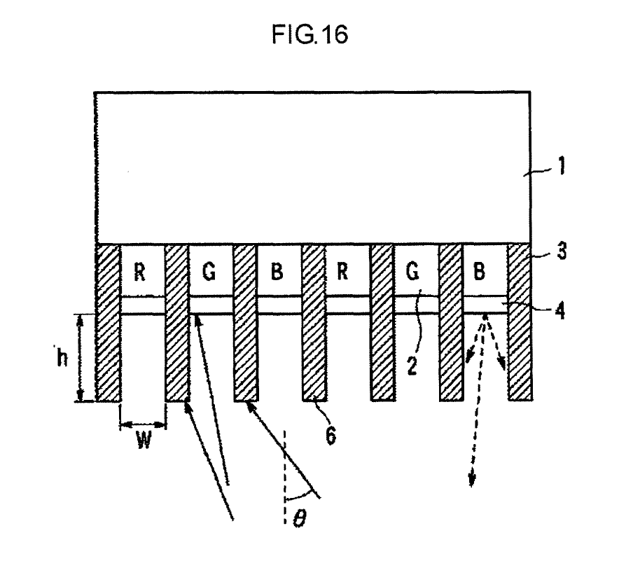

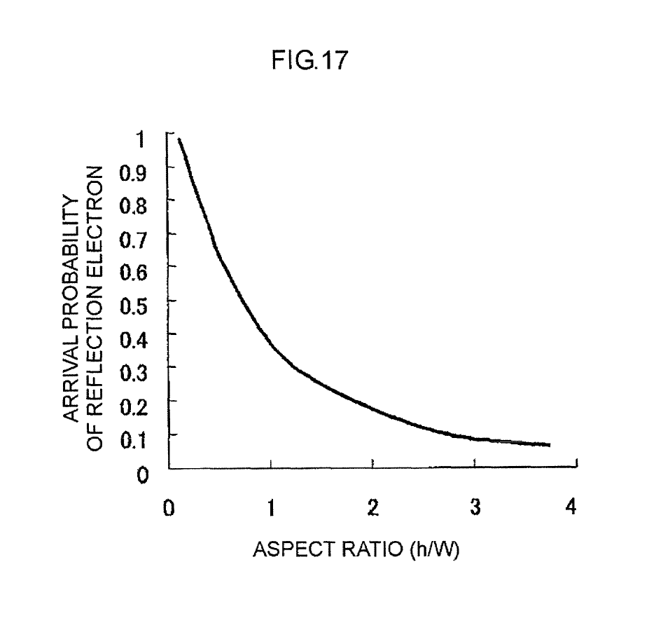

Next, a method for setting a degree of the mixture of colors at less than 80% as same as the above will be described with reference to FIG. 16 and FIG. 17. FIG. 16 shows a pattern diagram of a shielding effect of the barrier member 6 against ejection and reentry of reflection electrons. A solid line arrow in FIG. 16 shows a prevention effect of reentry and this is the same as above. In addition, a broken line arrow in FIG. 16 represents a trajectory of the reflection electron from the selected fluorescence substance. By hitting the barrier member 6, certain parts of the reflection electrons are prevented from ejecting. The larger h is for the width W of the fluorescence substance, namely, the larger an aspect ratio h/W is, these effects become larger. The result of obtaining these effects is shown in FIG. 17. The lateral axis of FIG. 17 represents the above-described aspect ratio and the longitudinal axis represents an arrival probability of the reflection electron. Defining the arrival amount of the reflection electron when there is no barrier member 6 as 1, FIG. 17 shows a degree of the arrival probability of the reflection electron when the aspect ratio of the barrier member 6 is larger. Accordingly, as described above, the aspect ratio h/W may be made larger than 0.35 in order to set the amount of the mixture of colors due to the reflection electron at less than 80%.

Hereinafter, a preferable embodiment of the image display apparatus according to the present invention will be described.

At first, a rear plate to be used for the image display apparatus of the present invention will be described with reference to FIG. 2. On the rear plate 8, an electron source substrate 14, on which row wirings 12, column wirings 13, inter-electrode insulation layers (not illustrated), and electron-emitting devices 5 are formed, is fixed. The electron source substrate 14 may be also used as the rear plate 8.

The electron-emitting device 5 is a surface conduction electron-emitting device, in which a conductive film having an electron emitting portion is connected between a pair of device-electrodes. The present embodiment is a multi electron beam source, in which N×M pieces of these electron-emitting devices 5 are arranged to be matrix-wired by M pieces of the row wirings 12 and N pieces of the column wirings 13 that are formed equally spaced respectively. In addition, according to the present embodiment, the row wiring 12 is positioned on the column wiring 13 via the inter-electrode insulation layer. A scanning signal is applied to the row wiring 12 via extraction terminals Dx1 to Dxm, and a modulation signal (an image signal) is applied to the column wiring 13 via extraction terminals Dy1 to Dyn.

The row wiring 12 and the column wiring 13 can be formed by applying a silver paste according to a screen printing method. In addition, by using a photolithography method, for example, the row wiring 12 and the column wiring 13 can be also formed.

As a constituent material of the row wiring 12 and the column wiring 13, other than the above-described silver paste, various kinds of conductive materials can be applied. For example, in the case of forming the row wiring 12 and the column wiring 13 by using the screen printing method, a application material including a metal and a glass paste can be used. Further, in the case of forming them by separating out a metal according to a plating method, a plating bath material can be applied.

Next, a face plate that is used for the image display apparatus according to the present invention will be described.

As a substrate of the face plate 1, an optical transparent substrate is used and a glass substrate is preferably used. On the inner face of the face plate 1, the fluorescence substance 2 that emits a light being irradiated by an electron beam is applied. According to the present invention, a color display is formed by color-coding the fluorescence substances 2 having a plurality of light emitting colors, and generally, fluorescence substances of three colors, namely, red, blue, and green are formed. As the fluorescence substance 2, a P22 fluorescence substance that is used for a CRT is preferably used, however, it is obvious that the present invention is not limited to this. As a method for forming the fluorescence substance, a patterning method such as a screen printing method and a photolithography method are preferable.

Between the fluorescence substances, a black material in a stripe or in a matrix is arranged. The structure in a stripe is referred to as a black stripe (BS) and the structure in a matrix is referred to as a black matrix (BM). As the effects of BS and BM, to improve a contrast by reducing a reflection of outside light and to prevent the adjacent colors from being mixed upon applying a fluorescence substance of each color may be considered. As materials of BS and BM, a low-melting glass plate containing a carbon black and a black colorant or the like is preferably used. As a method for forming BS (black stripe) and BM (black matrix), a patterning method such as a screen printing method and a photolithography method is preferable.

On a surface of the side of the rear plate of the fluorescent substance, a metal back (MB) 4 that is publicly known in a field of CRT is formed. As an effect of the metal back 4, to be operated as an electrode for applying an accelerated voltage for accelerating an electron from an electron source, to transmit through the accelerated electron, and to be operated as a reflection film for taking out the light emitted on the fluorescence substance to the side of an observer or the like are considered. The structure of the metal back is characteristically a very thin metal film. As a material, aluminum that easily transmits through an electron is preferably used. A voltage of 5 to 15 kV is applied to the metal back 4. The metal back 4 may be formed by using a filming that is publicly known in a field of CRT.

Next, the barrier member 6 that is a characteristic part of the present invention will be described. The barrier member 6 or the rib is disposed on a place where no fluorescence substance is arranged. Preferably, the barrier member 6 or the rib is disposed on BS (black stripe) and BM (black matrix). As an effect of the barrier member 6, as described above, the followings are considerable, namely,

(1) an interval defining member for disposing the aperture 11 between the face plate 1 and the spacer 7;

(2) an effect for shielding a reflection electron when the reflection electron reenters the fluorescence substance, and

(3) an effect for preventing the reflection electron from ejecting from the selected fluorescence substance.

Selecting the effect from among these effects, the barrier member 6 may be arranged. As shown in FIG. 9A, the barrier members 6 may be discretely arranged, as shown in FIG. 10A, the barrier members 6 may be arranged only on the opposite sides of a green fluorescence substance, and as shown in FIG. 14A, they may be arranged on the opposite sides of all fluorescent substances. A material of the barrier member 6 can be selected from among a metal such as Ni, Cu, Ag, and Al or a dielectric material such as a low-melting glass frit, ceramic, and polyimide. Here, it is preferable to form the barrier member 6 by using a paste made of ceramic and a low-melting glass frit that are used for a plasma display or the like from a point of view of a cost and easier forming. In addition, in order to use the barrier member also as BS and BM, the material of the barrier member may contain a black material. A method for manufacturing the barrier member 6 can be selected from among the screen printing method, the photolithography method, a sandblast method, and a blade forming method or the like. Here, the sandblast method is preferably used from a point of view of a degree of freedom and accuracy of a pattern and takt time or the like.

Next, the plate-like spacer 7 that is a characteristic of the present invention will be described. For the image display apparatus using an electron beam like a present invention, it is necessary to vacuate the inside of an image display panel in principle. This results in that an atmosphere pressure is placed on the face plate 1 and the rear plate 8. Accordingly, the spacer 7 as an interval defining member is needed between the face plate 1 and the rear plate 8. In addition, since the spacer 7 is arranged between the face plate 1 and the rear plate 8 having a high voltage applied thereon, a dielectric strength is required. Because the spacer 7 is required to be an insulating body, a material used for the spacer 7 includes an inorganic material such as glass and ceramic and an organic material such as polyimide having a high insulation withstand pressure and less discharge gas or the like. A method for manufacturing the spacer 7 includes a heating drawing method of a glass material, a polishing method of glass and ceramic or the like, a press molding method using a low-melting glass, and a method using a photosensitive polyimide or the like. From a point of view of easiness, the heating drawing method of a glass is preferably used. In addition, in the case of manufacturing the spacer 7 having the aperture 11 that is a characteristic of the present invention, the pressing molding method is preferably used from a point view of a degree of freedom of a shape. In addition, although a functional film may be formed on the surface of the spacer 7, a description thereof will not be described herein.

Further, according to the present invention, an average distance H from the face plate 1 to the rear plate 8 is preferably within the range of 1 mm<H<3 mm.

### EMBODIMENTS

Hereinafter, the present invention will be described in detail with a specific embodiment(s).

### First Embodiment

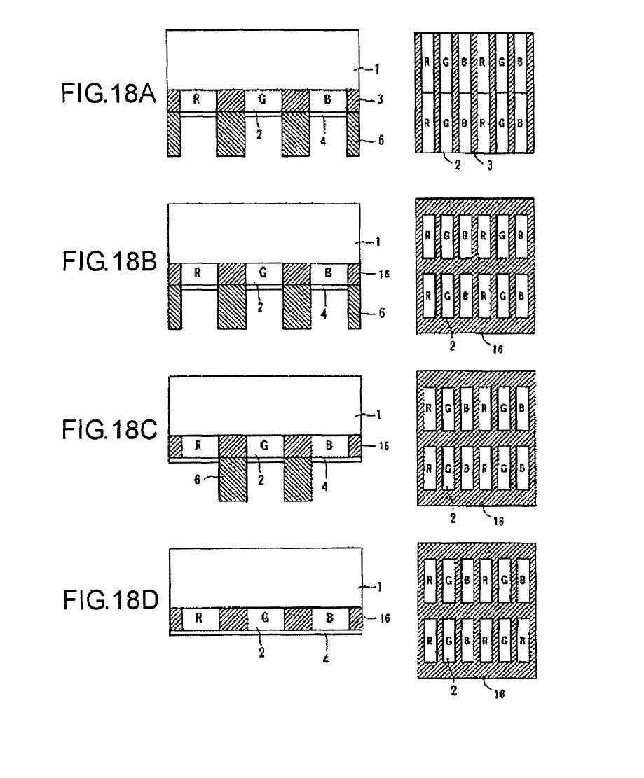

With reference to FIG. 14, FIG. 18A, and FIG. 12, a first embodiment of the present invention will be described. Further, in FIG. 18, a left side of the drawing is a cross sectional pattern diagram and a right side thereof is a plain pattern diagram.

As shown in FIG. 14 and FIG. 18A, the face plate 1 used for the image display apparatus of the present embodiment has the fluorescence substances 2 of three colors (red, green, and blue). The black stripe 3 is formed between the fluorescence substances so as to divide respective fluorescence substances. The fluorescence substances for all colors are shaped in such a manner that their widths are defined to be 150 μm, their lengths are defined to be 600 μm, and their thicknesses are defined to be 15 μm. The black stripe 3 is shaped in such a manner that its width is 50 μm, its length is 600 μm, and its thickness is 15 μm. A square pixel of 600 μm×600 μm is formed by the fluorescent substances 2 of three colors and the black stripe 3. In addition, on the black stripe 3, a rib 6 that is a characteristic part of the present invention is disposed. As same as the black stripe 3, the width of the rib 6 is defined to be 50 μm and the height thereof is defined to be 200 μm.

Further, the metal back 4 is disposed on the fluorescent substance. As the metal back 4, an aluminum thin film having a thickness 100 nm is used.

Next, the rear plate 1 used for the present embodiment will be described. On the rear plate 1, the electron source substrate 14 made of a surface conduction electron-emitting device is arranged. A pitch of the electron-emitting device 5 is defined so as to be 200 μm in a column direction and be 600 μm in a row direction, and the electron-emitting device 5 is arranged so as to be opposed to each fluorescence substance of the face plate 1. In addition, the row wiring 12 and the column wiring 13 are formed by a silver paste made of silver and a low-melting glass, which electrically connect the electron-emitting device 5. The detailed structures of the electron-emitting device 5 and the rear plate 1 and the methods for manufacturing the electron-emitting device 5 and the rear plate 1 will not be described herein.

Next, the spacer 7 will be described. The spacer 7 is formed by a glass substrate according to the heating drawing method with a thickness 200 μm, a height 1.8 mm, and a length longer than an image area (namely, an area where the electron source and the fluorescence substance are arranged and the image is displayed). The spacer 7 contacts a scanning wiring (row wiring) of the rear plate 8 and the rib 6 of the face plate 1 and a gap between the scanning wiring of the rear plate 8 and the rib 6 of the face plate 1 is defined to be 1.8 mm. Accordingly, a distance from the metal back 4 of the face plate 1 to the rear plate 8, namely, an interval of the panel is 2 mm. Further, the detailed description and the manufacturing method of the spacer 7 will not be described herein.

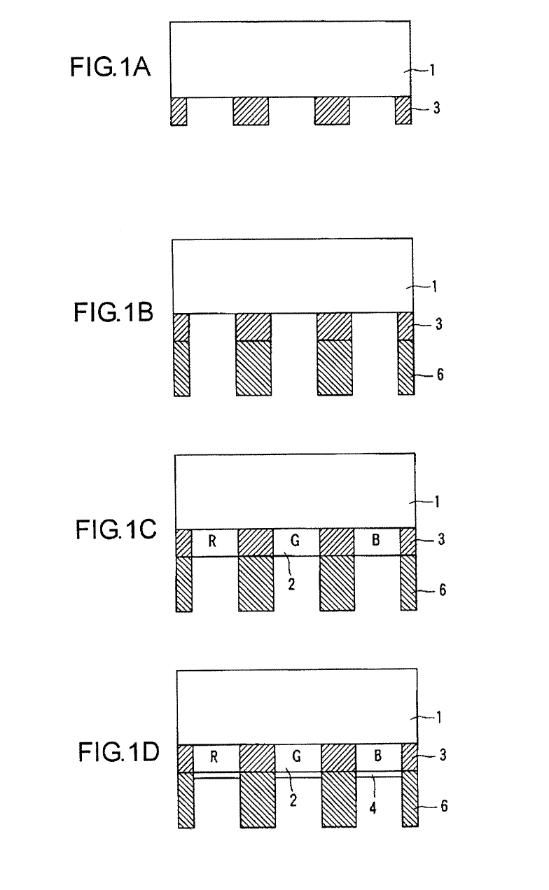

Next, a method for manufacturing the face plate 1 that is used for the present embodiment will be described with reference to FIG. 1.

### (Step 1)

The face plate substrate 1 made of a soda lime glass of a thickness 1.8 mm is cleaned.

### (Step 2)

A carbon black of a thickness 20 μm is applied on the face plate 1 by means of a slit coater. The carbon black is exposed in a desired pattern, developed, and calcinated so as to obtain a black stripe 3 in the above-described shape (FIG. 1A).

### (Step 3)

Subsequently, a paste of a rib material of a thickness 215 μm from the glass surface (200 μm from the black stripe 3) is applied by means of a slit coater. As the paste of the rib material, a paste containing alumina and a low-melting glass frit is used. Next, on the applied rib material, laminating a dry film resist (DFR) and carrying out exposure and development, a mask for sandblast is formed. Next, according to the sandblast method, the rib material disposed on an unnecessary part is removed. Then, separating the DFR, cleaning the substrate, and calcinating the rib material, the rib 6 formed in the shape above is obtained (FIG. 1B).

### (Step 4)

Next, the fluorescence substance 2 is applied to the aperture to be formed by the rib 6 and the black stripe 3. The fluorescence substances 2 are color-coded into respective colors, namely, R, G, and B so as to obtain a desired thickness according to the screen printing method. As the fluorescence substance 2, the P22 fluorescence substance is used. After that, by calcinating the rib material, the fluorescence substance in the above-described shape is obtained (FIG. 1C).

### (Step 5)

Next, the metal back 4 is formed according to the filming method that is publicly known in the filed of the CRT. At first, applying acrylic emulsion on the surface of the fluorescence substance by a spray method, the surface of the fluorescence substance is dried. Next, forming aluminum by a vacuum deposition method and calcinating aluminum in air, an organic component is removed so as to obtain a metal back in the above-described shape (FIG. 1D).

By using the face plate 1 manufactured as described above, the rear plate 8 forming the electron-emitting device 5, and the spacer 7, the image display apparatus is manufactured. The image quality is checked by lighting the manufactured image display apparatus so that the color difference in the vicinity of the spacer 7 is not noticeable and a high image quality having a natural displayed color can be obtained.

### Second Embodiment

Next, a second embodiment of the present invention will be described with reference to FIG. 18B. According to the present embodiment, a black matrix 16 in a grid is used in place of the black stripe 3. Other points are almost the same as the first embodiment, so that explanation thereof will not be described herein.

The black matrix 16 is used in order to improve a contrast of a bright place. The fluorescence substance has a high diffusion reflection rate, so that a whitish image is obtained on the bright place unless an average diffuse reflection rate is lowered by making the aperture ratio smaller.

Next, the measurement of the black matrix 16 will be described. Defining the width in the longitudinal direction of the black matrix 16 as 300 μm and the width in the lateral direction thereof as 50 μm, the aperture for one color is defined to be 150 μm×300 μm. The thickness thereof is defined to be 15 μm as same as the first embodiment. Moreover, the rib 6 in a stripe with a width 50 μm and a height 160 μm is formed according to the same method as the first embodiment. In addition, the panel interval is 1.96 mm.

Checking the image quality by lighting the manufactured image display apparatus, the color difference in the vicinity of the spacer 7 is not noticeable and a high image quality having a natural displayed color can be obtained. In addition, a good image quality having a high contrast even on a bright place can be obtained.

### Third Embodiment

Next, a third embodiment of the present invention will be described with reference to FIGS. 10A, 10B, and 18C. According to the present embodiment, it is characterized in that the rib members are disposed on the opposite sides of a green fluorescence substance having the highest light emission efficiency. Other points are almost the same as the first embodiment, so that explanation thereof will not be described herein.

On the black stripe 3 that is the same as the first embodiment, a rib 6 with a height 220 μm and a width 50 μm is formed. The rib 6 is formed on the opposite sides of the green fluorescence substance, however, no rib 6 is formed on the area sandwiched by red and blue (FIG. 18C). In addition, the panel interval is 2.02 mm.

Checking the image quality by lighting the manufactured image display apparatus, the color difference in the vicinity of the spacer 7 is not noticeable and a high image quality having a natural displayed color can be obtained.

### Fourth Embodiment

Next, a fourth embodiment of the present invention will be described with reference to FIGS. 6A, 6B, and 18D. According to the present embodiment, it is characterized in that the aperture 11 is disposed on the spacer 7 without disposing the rib 6 on the face plate 1. Other points are almost the same as the first embodiment, so that explanation thereof will not be described herein.

According to the present embodiment, differently from the first to third embodiments, the rib 6 is not disposed on the face plate 1, but other points, for example, the structure and the manufacturing method of the face plate 1 are the same as the first embodiment (FIG. 18D). In addition, as the spacer 7 of the present embodiment, that having the aperture 11 as shown in FIG. 6 is used. The measurement of the spacer 7 is defined so that its height is 2.0 mm, a distance from the face plate 1 to the aperture 11 is 0.4 mm, a height of the aperture is 1.0 mm, and the aperture ratio in the lateral direction is 0.7.

The spacer 7 is manufactured according to a press molding method by using a low-melting glass. Filling glass powders containing a low-melting glass in a carbon molding for obtaining a desired shape, the carbon molding is pressed while heating it at 500° C. After that, the carbon molding is cooled so that a desired spacer is obtained.

Forming an image display apparatus by using the spacer 7 that is manufactured as described above and checking the image quality, the color difference in the vicinity of the spacer 7 is not noticeable and a high image quality having a natural displayed color can be obtained.

### Fifth Embodiment

Next, a fifth embodiment of the present invention will be described. The present embodiment is the same as the second embodiment other than the height of the rib 6. The present embodiment is characterized in that an image display apparatus, whereby the color difference in the vicinity of the spacer 7 is not detected even if it is carefully observed and the mixture of colors is largely reduced by making the height of the rib 6 higher, can be obtained. Other points are almost the same as the second embodiment, so that explanation thereof will not be described herein.

In the face plate 1 that has the same structure as the second embodiment and that is manufactured by the same method as the second embodiment, the height of the rib member is defined to be 360 μm. In addition, the height of the spacer 7 is defined to be 1.4 mm and the panel interval is defined to be 1.76 mm.

Checking the image quality by lighting the manufactured image display apparatus as described above, the color difference in the vicinity of the spacer 7 is not detected even when it is carefully observed. Further, the displayed color is checked so that a natural image having high color purity can be obtained.

### Comparative Example

Next, an example of an image display apparatus having a plate-like spacer as a comparative example will be described with reference to FIG. 3. Although the basic structure of each member is the same as the first embodiment, there is no rib 6 disposed on the face plate 1 and there is no aperture 11 on the spacer 7.

The image quality is checked by lighting the manufactured image display apparatus as described above so that the color difference in the vicinity of the spacer 7 from other places is recognized. Therefore, an image having susceptibility is obtained. In addition, a displayed color is checked so that an unnatural displayed color is found on a certain part of the image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-274998, filed on Oct. 6, 2006, which is hereby incorporated by reference herein in its entirety.

What is claimed is:

1. An image display apparatus comprising:
a rear plate having a plurality of electron-emitting devices;
a face plate having a plurality of fluorescence substances with different light emitting colors; and
a plate-like spacer for defining an interval between the rear plate and the face plate,
wherein the spacer has an aperture that allows a reflection electron generated on the face plate to pass through the plate-like spacer in a thickness direction and to reenter the face plate, and
wherein the amount Et of the reflection electron that is irradiated to the fluorescence substance closest to the spacer by passing through the aperture is defined as
Et>0.3×En,
where the amount of the reflection electron to be irradiated to the fluorescence substance is En when no spacer is located.

2. An image display apparatus according to claim 1, wherein
A=a/H,
B=b/H, and
B×C>0.9×A+0.13
are satisfied,
where H is an average distance between the rear plate and the face plate, a is a shortest distance between the aperture of the spacer and the face plate, b is an aperture width in a height direction of the spacer of the aperture, and C is an aperture ratio in a longitudinal direction of the spacer of the aperture.

3. An image display apparatus according to claim 1, wherein a relation between En and Et satisfies
Et>0.7×En.

4. An image display apparatus according to claim 2, wherein a relation among A, B, and C satisfies
B×C>2.3×A+0.5.

5. An image display apparatus according to claim 1, wherein the aperture is disposed between the spacer and the face plate.

6. An image display apparatus according to claim 1, wherein an average distance H between the face plate and the rear plate satisfies
1 mm<H<3 mm.

7. An image display apparatus comprising:
a rear plate having a plurality of electron-emitting devices;
a face plate having a plurality of fluorescence substances with different light emitting colors; and
a plate-like spacer for defining an interval between the rear plate and the face plate,
wherein barrier members are arranged on the face plate in a direction that crosses the plate-like spacer, and
wherein the barrier members are arranged at the opposite sides of the fluorescence substance having the highest light emission efficiency among the fluorescence substances with different light emitting colors, and
wherein a height h of the barrier member has a relation satisfying
h>0.1×H
for a distance H between the face plate and the rear plate.

8. An image display apparatus according to claim 7, wherein the relation between h and H satisfies
h>0.3×H.

9. An image display apparatus according to claim 7, wherein
R1<0.8×R2
is satisfied,
where R1 is an amount of reflection electrons that reach a fluorescence substance sandwiched by the barrier members, and R2 is an amount of reflection electrons that reach a fluorescence substance when there is no barrier member.

10. An image display apparatus according to claim 7, wherein
h/W>0.5
is satisfied,
where h is the height of the barrier member, and W is a width of the fluorescence substance sandwiched by the barrier members.

11. An image display apparatus according to claim 7, wherein the average distance H between the face plate and the rear plate satisfies
1 mm<H<3 mm.

12. An image display apparatus comprising:
a rear plate having a plurality of electron-emitting devices;
a face plate having a plurality of fluorescence substances with different light emitting colors; and
a plate-like spacer for defining an interval between the rear plate and the face plate,
wherein barrier members are arranged on the face plate in a direction that crosses the plate-like spacer, and
wherein the barrier members are arranged among the fluorescence substances with different light emitting colors, and
wherein a height h of the barrier member has a relation satisfying
h>0.075×H
for a distance H between the face plate and the rear plate.

13. An image display apparatus according to claim 12, wherein the relation between h and H satisfies
h>0.2×H.

14. An image display apparatus according to claim 12, wherein
R1<0.8×R2
is satisfied,
where R1 is an amount of reflection electrons that reach a fluorescence substance, and R2 is an amount of reflection electrons that reach a fluorescence substance when there is no barrier member.

15. An image display apparatus according to claim 12, wherein
h/W>0.35
is satisfied,
where h is the height of the barrier member, and W is a width of the fluorescence substance sandwiched by the barrier members.

16. An image display apparatus according to claim 12, wherein the average distance H between the face plate and the rear plate satisfies
1 mm<H<3 mm.
